(19) United States
(12) Patent Application Publication
(10) Pub. No.: US 2017/0124656 A1
(43) Pub. Date: May 4, 2017

(54) METHOD AND SYSTEM FOR PROVIDING SUSTAINABLE PERFORMANCE INSTRUMENTS (SPI)

(71) Applicant: ENVIRONMENTAL FINANCIAL PRODUCTS, LLC, Chicago, IL (US)

(72) Inventors: Richard L. SANDOR, Chicago, IL (US); Murali KANAKASABAI, Chicago, IL (US); Nathan J. CLARK, Chicago, IL (US); Rafael L. MARQUES, Chicago, IL (US)

(21) Appl. No.: 15/404,858

(22) Filed: Jan. 12, 2017

Related U.S. Application Data
(63) Continuation of application No. 13/736,162, filed on Jan. 8, 2013, now abandoned.
Application No. 13/736,162 is a continuation-in-part of application No. 13/570,930, filed on Aug. 9, 2012.
Application No. 13/570,930 is a continuation-in-part of application No. 13/091,902, filed on Apr. 21, 2011, now abandoned.

(51) Int. Cl. G06Q 40/06

(52) U.S. Cl. CPC G06Q 40/06

(57) ABSTRACT

A method and system for designing and providing sustainable performance instruments. A new type of financial instruments called Sustainable Performance Instruments (SPI) provides investors with returns tied to the actual performance outcomes or impacts from a sustainable social or environments program or other policy interventions. The SPI incentivize investors with higher returns and/or borrowers with lower rates based on a scale on social and/or environmental and/or other objectives. The SPI are a new way to fund innovative projects in public and private sectors that may not be able to find financing or funding using conventional mechanisms. The SPI hold executors of the project or program accountable by directly tying financial returns and other benefits to actual measurable performance benchmarks or observable impacts.

### CROSS REFERENCE TO RELATED APPLICATIONS

This application is a continuation of U.S. application Ser. No. 13/736,162 filed on Jan. 8, 2013, which is a continuation-in-part of U.S. application Ser. No. 13/570,930 filed on Aug. 9, 2012, which is a continuation-in-part of U.S. application Ser. No. 13/091,902 filed on Apr. 21, 2011, the contents of each of which are expressly incorporated herein by reference thereto.

### FIELD OF INVENTION

This invention relates to providing financial instruments designed to fund a specific type of program or project with investor returns directly tied to achievement of pre-determined performance outcomes from the program or project activity. More specifically, it relates to a method and system for providing sustainable performance instruments (SPI) to raise funds for projects or programs with broad applications in social, environmental and other policy interventions.

### BACKGROUND OF THE INVENTION

Organizations working towards sustainable goals, including social and environmental objectives or other public or private policy goals, have traditionally met their funding needs either through philanthropy, foundation or private grant funding, governmental program funding and in some cases through issuance of traditional bond instruments. These traditional sources of funding are fraught with problems.

One problem is the inefficiencies associated with funding projects with social or environmental objectives. Funding typically must be obtained from multiple private, public and government sources.

Another problem is a lack of sufficient emphasis on performance outcomes from the social or environmental program or project. Once a program or project is funded, it typically need not necessarily have to achieve any measurable success.

Another problem is trying to measure outcomes of a program or project to determine any results at all.

Thus, it is desirable to solve some of the problems associated with providing funding for sustainable objectives including social, environmental or other projects that are based on actual program or project outcomes.

### SUMMARY OF THE INVENTION

In accordance with preferred embodiments of the present invention, some of the problems associated providing funding for social and environmental or other projects are overcome. A method and system for providing sustainable performance instruments (SPI) is provided.

A new type of financial instruments called Sustainable Performance Instruments (SPI) provides investors with returns tied to the actual performance outcomes or impacts from implementation of a policy intervention including social or environmental program or other projects. The SPI incentivize investors with higher returns and/or borrowers with lower rates based on a scale on social and/or environmental and/or other objectives. The SPI allow sharing the gains between investors and issuers of achieving social objectives. The SPI are a new way to fund innovative projects in public and private sectors that may not be able to find financing or funding using conventional mechanisms. The SPI hold executors of the project or program accountable by directly tying financial returns to actual measurable performance benchmarks or observable impacts. SPI also provides new avenues for public-private partnerships by bringing investors to invest in social, environmental and public policy projects as mainstream investments. SPI are new, novel financial instruments as they bring the private and public sector share gains from a program intervention and achievement of the stated policy goals.

The foregoing and other features and advantages of preferred embodiments of the present invention will be more readily apparent from the following detailed description. The detailed description proceeds with references to the accompanying drawings.

### BRIEF DESCRIPTION OF THE DRAWINGS

Preferred embodiments of the present invention are described with reference to the following drawings, wherein:

FIG. 1 is a block diagram illustrating an exemplary electronic information display system;

FIG. 2 is a block diagram illustrating an exemplary electronic information display system;

FIG. 3 is a block diagram illustrating an exemplary networking protocol stack;

FIGS. 4A and 4B are a flow diagram illustrating a method for providing sustainable performance instruments (SPIs); and

FIGS. 5A and 5B are a flow diagram illustrating a method for providing sustainable performance instruments (SPIs).

### DETAILED DESCRIPTION OF THE INVENTION

### Exemplary Performance Based Financial Instrument System

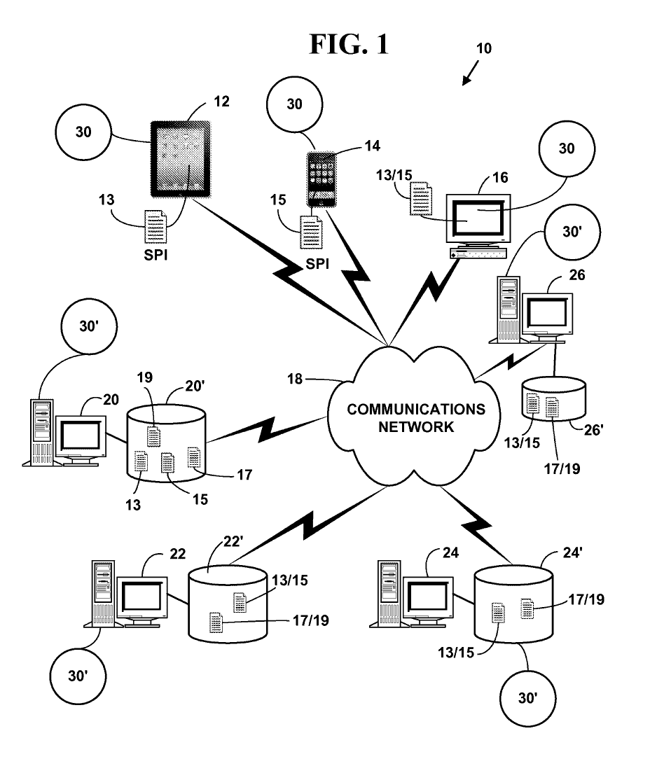

FIG. 1 is a block diagram illustrating an exemplary performance based financial instrument system 10. The exemplary performance based financial instrument system 10 includes, but is not limited to, one or more target network devices 12, 14, 16 (only three of which are illustrated) each with one or more processors and each with a non-transitory computer readable medium.

The one or more target network devices 12, 14, 16 include, but are not limited to, multimedia capable desktop and laptop computers, tablet computers, facsimile machines, mobile phones, non-mobile phones, smart phones, Internet phones, Internet appliances, personal digital/data assistants (PDA), two-way pagers, digital cameras, portable game consoles (Play Station Portable by Sony, Game Boy by Sony, Nintendo DSI, etc.), non-portable game consoles (Xbox by Microsoft, Play Station by Sony, Wii by Nintendo, etc.), cable television (CATV), satellite television (SATV) and Internet television set-top boxes, digital televisions including high definition television (HDTV), three-dimensional (3DTV) televisions and other types of network devices.

The one or more smart network devices 12, 14, 16 include smart phones such as the iPhone by Apple, Inc., Blackberry Storm and other Blackberry models by Research In Motion, Inc. (RIM), Droid by Motorola, Inc. HTC, Inc. other types of smart phones, etc. However, the present invention is not limited to such smart phone devices, and more, fewer or other devices can be used to practice the invention.

A “smart phone” is a mobile phone that offers more advanced computing ability and connectivity than a contemporary basic feature phone. Smart phones and feature phones may be thought of as handheld computers integrated with a mobile telephone, but while most feature phones are able to run applications based on platforms such as Java ME, a smart phone usually allows the user to install and run more advanced applications. Smart phones and/or tablet computers run complete operating system software providing a platform for application developers.

The operating systems include the iPhone OS, Android, Windows, etc. iPhone OS is a proprietary operating system for the Apple iPhone. The Android is an open source operating system platform backed by Google, along with major hardware and software developers (such as Intel, HTC, ARM, Motorola and Samsung, etc.), that form the Open Handset Alliance.

The one or more smart network devices 12, 14, 16 include tablet computers such as the iPad, by Apple, Inc., the HP Tablet, by Hewlett Packard, Inc., the Playbook, by RIM, Inc., the Tablet, by Sony, Inc.

The target network devices 12, 14, 16 are in communications with a communications network 18 via one or more wired and/or wireless communications interfaces.

The plural server network devices 22, 24, 26 send and receive desired performance based financial instrument content 13, 15, etc. stored on the communications network 18.

The communications network 18 includes, but is not limited to, communications over a wire connected to the target network devices, wireless communications, and other types of communications using one or more communications and/or networking protocols.

Plural server network devices 20, 22, 24, 26 (only four of which are illustrated) each with one or more processors and a non-transitory computer readable medium include one or more associated databases 20′, 22′, 24′, 26′. The plural network devices 20, 22, 24, 26 are in communications with the one or more target devices 12, 14, 16 via the communications network 18.

Plural server network devices 20, 22, 24, 26 (only four of which are illustrated) are physically located on one more public networks, private networks, community network and/or hybrid networks comprising the communications network 18.

One or more server network devices (e.g., 20, 22, 24, 26, etc.) securely store portions 13′, 15′ of desired performance based financial instrument electronic content 13, 15.

The plural server network devices 20, 22, 24 26, include, but are not limited to, World Wide Web servers, Internet servers, search engine servers, vertical search engine servers, social networking site servers, file servers, other types of electronic information servers, and other types of server network devices (e.g., edge servers, firewalls, routers, gateways, etc.).

The plural server network devices 20, 22, 24, 26 also include, but are not limited to, network servers used for computing providers, etc.

The communications network 18 includes, but is not limited to, a wired and/or wireless communications network comprising one or more portions of: the Internet, an intranet, a Local Area Network (LAN), a wireless LAN (WiLAN), a Wide Area Network (WAN), a Metropolitan Area Network (MAN), a Public Switched Telephone Network (PSTN), a Wireless Personal Area Network (WPAN) and other types of wired and/or wireless communications networks 18.

The communications network 18 includes one or more gateways, routers, bridges and/or switches. A gateway connects computer networks using different network protocols and/or operating at different transmission capacities. A router receives transmitted messages and forwards them to their correct destinations over the most efficient available route. A bridge is a device that connects networks using the same communications protocols so that information can be passed from one network device to another. A switch is a device that filters and forwards packets between network segments based on some pre-determined sequence (e.g., timing, sequence number, etc.).

An operating environment for the network devices of the exemplary market estimate information display system 10 include a processing system with one or more high speed Central Processing Unit(s) (CPU), processors, one or more memories and/or other types of non-transitory computer readable mediums. In accordance with the practices of persons skilled in the art of computer programming, the present invention is described below with reference to acts and symbolic representations of operations or instructions that are performed by the processing system, unless indicated otherwise. Such acts and operations or instructions are referred to as being “computer-executed,” “CPU-executed,” or “processor-executed.”

It will be appreciated that acts and symbolically represented operations or instructions include the manipulation of electrical information by the CPU or processor. An electrical system represents data bits which cause a resulting transformation or reduction of the electrical information or biological information, and the maintenance of data bits at memory locations in a memory system to thereby reconfigure or otherwise alter the CPU's or processor's operation, as well as other processing of information. The memory locations where data bits are maintained are physical locations that have particular electrical, magnetic, optical, or organic properties corresponding to the data bits.

The data bits may also be maintained on a non-transitory computer readable medium including magnetic disks, optical disks, organic memory, and any other volatile (e.g., Random Access Memory (RAM)) or non-volatile (e.g., Read-Only Memory (ROM), flash memory, etc.) mass storage system readable by the CPU. The non-transitory computer readable medium includes cooperating or interconnected computer readable medium, which exist exclusively on the processing system or can be distributed among multiple interconnected processing systems that may be local or remote to the processing system.

### Exemplary Electronic Content Display System

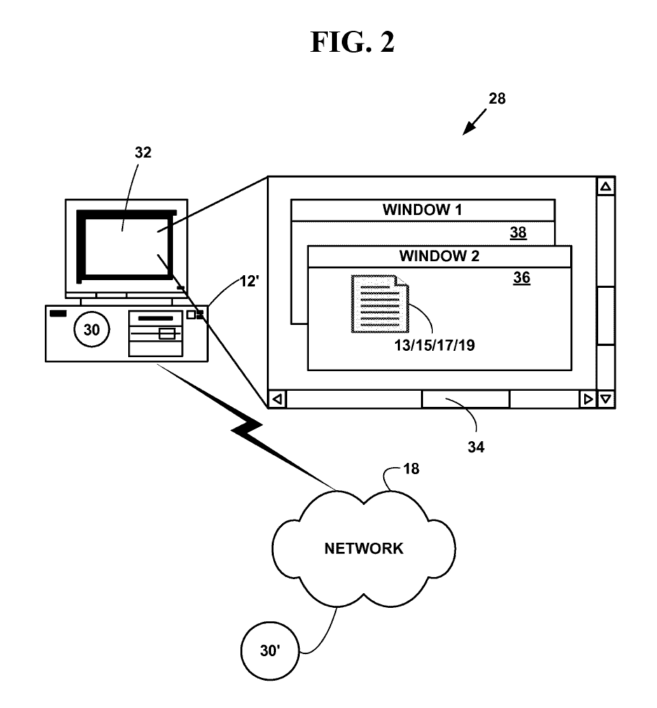

FIG. 2 is a block diagram illustrating an exemplary performance based financial instrument display system 28. The exemplary market estimate information display system includes, but is not limited to a target network device (e.g., 12, etc.) with an application 30 and a display component 32. The application 30 presents a graphical user interface (GUI) 34 on the display 32 component. The GUI 32 presents a multi-window 36, 38, etc. (only two of which are illustrated) interface to a user.

In one embodiment of the invention, the application 30 is a software application. However, the present invention is not limited to this embodiment and the application 30 can be hardware, firmware, hardware and/or any combination thereof. However, the present invention is not limited these embodiments and other embodiments can be used to practice the invention

In another embodiment, a portion of the application 30 is executing on the target network devices 12, 14, 16 and another portion of the application 30′ is executing on the server network devices 20, 22, 24, 26 However, the present invention is not limited these embodiments and other embodiments can be used to practice the invention.

### Exemplary Networking Protocol Stack

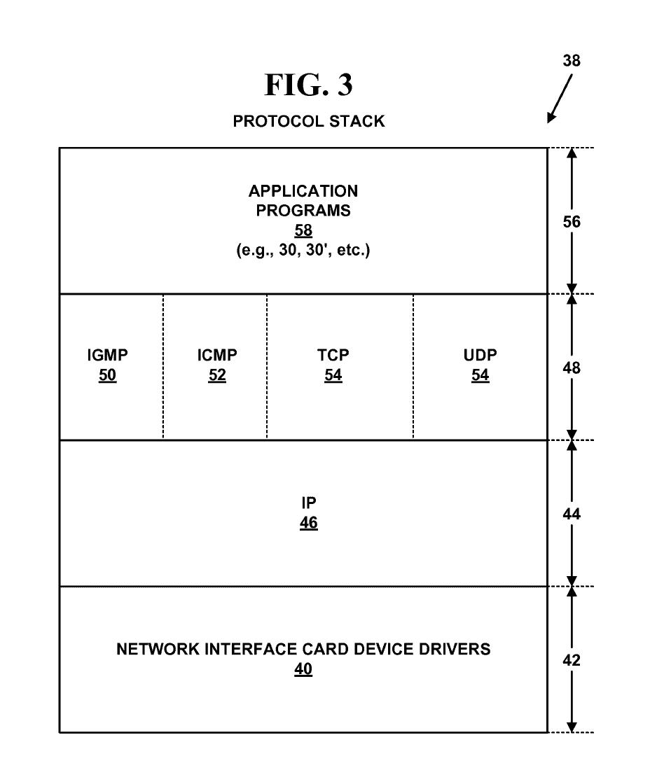

FIG. 3 a block diagram illustrating a layered protocol stack 38 for network devices in the market estimate information display system 10. The layered protocol stack 38 is described with respect to Internet Protocol (IP) suites comprising in general from lowest-to-highest, a link 42, network 44, transport 48 and application 56 layer. However, more or fewer layers could also be used, and different layer designations could also be used for the layers in the protocol stack 38 (e.g., layering based on the Open Systems Interconnection (OSI) model including from lowest-to-highest, a physical, data-link, network, transport, session, presentation and application layer.).

The network devices 12, 14, 16, 20, 22, 24, 26 are connected to the communication network 18 with Network Interface Card (NIC) cards including device drivers 40 in a link layer 42 for the actual hardware connecting the network devices 12, 14, 16, 20, 22, 24, 26 to the communications network 18. For example, the NIC device drivers 40 may include a serial port device driver, a digital subscriber line (DSL) device driver, an Ethernet device driver, a wireless device driver, a wired device driver, etc. The device drivers interface with the actual hardware being used to connect the network devices to the communications network 18. The NIC cards have a medium access control (MAC) address that is unique to each NIC and unique across the whole network 18. The Medium Access Control (MAC) protocol is used to provide a data link layer of an Ethernet LAN system and for other network systems.

Above the link layer 42 is a network layer 44 (also called the Internet Layer for Internet Protocol (IP) suites). The network layer 44 includes, but is not limited to, an IP layer 46.

IP 46 is an addressing protocol designed to route traffic within a network or between networks. However, more fewer or other protocols can also be used in the network layer 44, and the present invention is not limited to IP 46. For more information on IP 54 see IETF RFC-791, incorporated herein by reference.

Above network layer 44 is a transport layer 48. The transport layer 48 includes, but is not limited to, an optional Internet Group Management Protocol (IGMP) layer 50, a Internet Control Message Protocol (ICMP) layer 52, a Transmission Control Protocol (TCP) layer 52 and a User Datagram Protocol (UDP) layer 54. However, more, fewer or other protocols could also be used in the transport layer 48.

Optional IGMP layer 50, hereinafter IGMP 50, is responsible for multicasting. For more information on IGMP 50 see RFC-1112, incorporated herein by reference. ICMP layer 52, hereinafter ICMP 52 is used for IP 46 control. The main functions of ICMP 52 include error reporting, reachability testing (e.g., pinging, etc.), route-change notification, performance, subnet addressing and other maintenance. For more information on ICMP 52 see RFC-792, incorporated herein by reference. Both IGMP 50 and ICMP 52 are not required in the protocol stack 38. ICMP 52 can be used alone without optional IGMP layer 50.

TCP layer 54, hereinafter TCP 54, provides a connection-oriented, end-to-end reliable protocol designed to fit into a layered hierarchy of protocols which support multi-network applications. TCP 54 provides for reliable inter-process communication between pairs of processes in network devices attached to distinct but interconnected networks. For more information on TCP 54 see RFC-793, incorporated herein by reference.

UDP layer 56, hereinafter UDP 56, provides a connectionless mode of communications with datagrams in an interconnected set of computer networks. UDP 56 provides a transaction oriented datagram protocol, where delivery and duplicate packet protection are not guaranteed. For more information on UDP 56 see RFC-768, incorporated herein by reference. Both TCP 54 and UDP 56 are not required in protocol stack 38. Either TCP 54 or UDP 56 can be used without the other.

Above transport layer 48 is an application layer 56 where application programs 58 (e.g., 30, 30′, etc.) to carry out desired functionality for a network device reside. For example, the application programs 54 for the client network devices 12, 14, 16 may include a web-browsers or other application programs, application program 30, while application programs for the server network devices 20, 22, 24, 26 may include other application programs (e.g., 30′, etc.).

However, the protocol stack 38 is not limited to the protocol layers illustrated and more, fewer or other layers and protocols can also be used in protocol stack 38. In addition, other protocols from the Internet Protocol suites (e.g., Simple Mail Transfer Protocol, (SMTP), Hyper Text Transfer Protocol (HTTP), File Transfer Protocol (FTP), Dynamic Host Configuration Protocol (DHCP), DNS, etc.) and/or other protocols from other protocol suites may also be used in protocol stack 38.

Preferred embodiments of the present invention include network devices and wired and wireless interfaces that are compliant with all or part of standards proposed by the Institute of Electrical and Electronic Engineers (IEEE), International Telecommunications Union-Telecommunication Standardization Sector (ITU), European Telecommunications Standards Institute (ETSI), Internet Engineering Task Force (IETF), U.S. National Institute of Security Technology (NIST), American National Standard Institute (ANSI), Wireless Application Protocol (WAP) Forum, Bluetooth Forum, or the ADSL Forum. However, network devices based on other standards could also be used.

### Wireless Interfaces

In one embodiment of the present invention, the wireless interfaces on network devices 12, 14, 16, 20, 22, 24, 26 include but are not limited to, 3G and/or 4G IEEE 802.11a, 802.11b, 802.11g, 802.11n, 802.15.4 (ZigBee), “Wireless Fidelity” (Wi-Fi), “Worldwide Interoperability for Microwave Access” (WiMAX), ETSI High Performance Radio Metropolitan Area Network (HIPERMAN) or “RF Home” wireless interfaces. In another embodiment of the present invention, the wireless sensor device may include an integral or separate Bluetooth and/or infra data association (IrDA) module for wireless Bluetooth or wireless infrared communications. However, the present invention is not limited to such an embodiment and other 802.11xx and other types of wireless interfaces can also be used.

802.11b is a short-range wireless network standard. The IEEE 802.11b standard defines wireless interfaces that provide up to 11 Mbps wireless data transmission to and from wireless devices over short ranges. 802.11a is an extension of the 802.11b and can deliver speeds up to 54M bps. 802.11g deliver speeds on par with 802.11a. However, other 802.11XX interfaces can also be used and the present invention is not limited to the 802.11 protocols defined. The IEEE 802.11a, 802.11b and 802.11g standards are incorporated herein by reference.

Wi-Fi is a type of 802.11xx interface, whether 802.11b, 802.11a, dual-band, etc. Wi-Fi devices include an RF interfaces such as 2.4 GHz for 802.11b or 802.11g and 5 GHz for 802.11a.

802.15.4 (Zigbee) is low data rate network standard used for mesh network devices such as sensors, interactive toys, smart badges, remote controls, and home automation. The 802.15.4 standard provides data rates of 250 kbps, 40 kbps, and 20 kbps., two addressing modes; 16-bit short and 64-bit IEEE addressing, support for critical latency devices, such as joysticks, Carrier Sense Multiple Access/Collision Avoidance, (CSMA-CA) channel access, automatic network establishment by a coordinator, fully handshaked protocol for transfer reliability, power management to ensure low power consumption for multi-month to multi-year battery usage and up to 16 channels in the 2.4 GHz Industrial, Scientific and Medical (ISM) band (Worldwide), 10 channels in the 915 MHz (US) and one channel in the 868 MHz band (Europe). The IEEE 802.15.4-2003 standard is incorporated herein by reference.

WiMAX is an industry trade organization formed by leading communications component and equipment companies to promote and certify compatibility and interoperability of broadband wireless access equipment that conforms to the IEEE 802.16XX and ETSI HIPERMAN. HIPERMAN is the European standard for metropolitan area networks (MAN).

The IEEE The 802.16a and 802.16g standards are wireless MAN technology standard that provides a wireless alternative to cable, DSL and T1/E1 for last mile broadband access. It is also used as complimentary technology to connect IEEE 802.11XX hot spots to the Internet.

The IEEE 802.16a standard for 2-11 GHz is a wireless MAN technology that provides broadband wireless connectivity to fixed, portable and nomadic devices. It provides up to 50-kilometers of service area range, allows users to get broadband connectivity without needing direct line of sight with the base station, and provides total data rates of up to 280 Mbps per base station, which is enough bandwidth to simultaneously support hundreds of businesses with T1/E1-type connectivity and thousands of homes with DSL-type connectivity with a single base station. The IEEE 802.16g provides up to 100 Mbps.

The IEEE 802.16e standard is an extension to the approved IEEE 802.16/16a/16g standard. The purpose of 802.16e is to add limited mobility to the current standard which is designed for fixed operation.

The ESTI HIPERMAN standard is an interoperable broadband fixed wireless access standard for systems operating at radio frequencies between 2 GHz and 11 GHz.

The IEEE 802.16a, 802.16e and 802.16g standards are incorporated herein by reference. WiMAX can be used to provide a WLP.

The ETSI HIPERMAN standards TR 101 031, TR 101 475, TR 101 493-1 through TR 101 493-3, TR 101 761-1 through TR 101 761-4, TR 101 762, TR 101 763-1 through TR 101 763-3 and TR 101 957 are incorporated herein by reference. ETSI HIPERMAN can be used to provide a WLP.

In one embodiment, the plural server network devices 20, 22, 24, 26 include a connection to plural network interface cards (NICs) in a backplane connected to a communications bus. The NIC cards provide gigabit/second (1×10⁹ bits/second) communications speed of electronic information. This allows “scaling out” for fast electronic content retrieval. The NICs are connected to the plural server network devices 20, 22, 24, 26 and the communications network 18. However, the present invention is not limited to the NICs described and other types of NICs in other configurations and connections with and/or without a buses can also be used to practice the invention.

In one embodiment, network devices 12, 14, 16, 20, 22, 24, 26 and wired and wireless interfaces including the NICs include “4G” components. “4G” refers to the fourth generation of wireless communications standards and speeds of 100 megabits/second to gigabits/second or more. 4G includes peak speed requirements for 4G service at least 100 Mbit/s for high mobility communication (e.g., trains, vehicles, etc.) and 1 Gbit/s for low mobility communication (e.g., pedestrians and stationary users, etc.).

4G technologies are a successor to 3G and 2G standards. The nomenclature of the generations generally refers to a change in the fundamental nature of the service. The first was the move from analogue (1G) to digital (2G) transmission. This was followed by multi-media support, spread spectrum transmission and at least 200 kbits/second (3G). The 4G NICs include IP packet-switched NICs, wired and wireless ultra-broadband (i.e., gigabit speed) access NICs, Worldwide Interoperability for Microwave Access (WiMAX) NICs WiMAX Long Term Evolution (LTE) and/or multi-carrier transmission NICs. However, the present invention is not limited to this embodiment and 1G, 2G and 3G and/or any combination thereof, with or with 4G NICs can be used to practice the invention.

In one embodiment of the invention, the WiMAX interfaces includes WiMAX 4G Long Term Evolution (LTE) interfaces. The ITU announced in December 2010 that WiMAX and LTE are 4G technologies. One of the benefits of 4G LTE is the ability to take advantage of advanced topology networks including those on communications networks 18 such as optimized heterogeneous networks with a mix of macrocells with low power nodes such as picocells, femtocells and new relay nodes. LTE further improves the capacity and coverage, and helps ensures user fairness. 4G LTE also introduces multicarrier technologies for ultra-wide bandwidth use, up to 100 MHz of spectrum supporting very high data rates.

In one embodiment, of the invention, the wireless interfaces also include wireless personal area network (WPAN) interfaces. As is known in the art, a WPAN is a personal area network for interconnecting devices centered around an individual person's devices in which the connections are wireless. A WPAN interconnects all the ordinary computing and communicating devices that a person has on their desk (e.g. computer, etc.) or carry with them (e.g., PDA, mobile phone, smart phone, table computer two-way pager, etc.)

A key concept in WPAN technology is known as “plugging in.” In the ideal scenario, when any two WPAN-equipped devices come into close proximity (within several meters and/or feet of each other) or within a few miles and/or kilometers of a central server (not illustrated), they can communicate via wireless communications as if connected by a cable. WPAN devices can also lock out other devices selectively, preventing needless interference or unauthorized access to secure information. Zigbee is one wireless protocol used on WPAN networks such as communications network 18.

However, the present invention is not limited to such wireless interfaces and wireless networks and more, fewer and/or other wireless interfaces can be used to practice the invention.

### Wired Interfaces

In one embodiment of the present invention, the wired interfaces include wired interfaces and corresponding networking protocols for wired connections to the Public Switched Telephone Network (PSTN) and/or a cable television network (CATV) and/or satellite television networks (SATV) and/or three-dimensional television (3DTV), including HDTV that connect the network devices 12, 14, 16, 20, 22, 24, 26 via one or more twisted pairs of copper wires, digital subscriber lines (e.g. DSL, ADSL, VDSL, etc.) coaxial cable, fiber optic cable, other connection media or other connection interfaces. The PSTN is any public switched telephone network provided by AT&T, GTE, Sprint, MCI, SBC, Verizon and others. The CATV is any cable television network provided by the Comcast, Time Warner, etc. However, the present invention is not limited to such wired interfaces and more, fewer and/or other wired interfaces can be used to practice the invention.

### Television Services

In one embodiment, the applications 30, 30′ provide performance based financial instrument computing services from television services over the communications network 18. The television services include digital television services, including, but not limited to, cable television, satellite television, high-definition television, three-dimensional, televisions and other types of network devices.

However, the present invention is not limited to such television services and more, fewer and/or other television services can be used to practice the invention.

### Internet Television Services

In one embodiment, the applications 30, 30′ provide performance based financial instrument computing services from Internet television services over the communications network 18. The television services include Internet television, Web-TV, and/or Internet Protocol Television (IPtv) and/or other broadcast television services.

“Internet television” allows users to choose a program or the television show they want to watch from an archive of programs or from a channel directory. The two forms of viewing Internet television are streaming content directly to a media player or simply downloading a program to a viewer's set-top box, game console, computer, or other mesh network device.

“Web-TV” delivers digital content via non-mesh broadband and mobile networks. The digital content is streamed to a viewer's set-top box, game console, computer, or other mesh network device.

“Internet Protocol television (IPtv)” is a system through which Internet television services are delivered using the architecture and networking methods of the Internet Protocol Suite over a packet-switched network infrastructure, e.g., the Internet and broadband Internet access networks, instead of being delivered through traditional radio frequency broadcast, satellite signal, and cable television formats.

However, the present invention is not limited to such Internet Television services and more, fewer and/or other Internet Television services can be used to practice the invention.

### Social Networking Services

In one embodiment, the applications 30, 30′ provide performance based financial instrument computing services from one more social networking services including to/from one or more social networking web-sites (e.g., FACEBOOK, YOUTUBE, TWITTER, MY-SPACE, MATCH.COM, E-HARMONY, GROUPON, SOCIAL LIVING, etc.). The social networking web-sites also include, but are not limited to, social couponing sites, dating web-sites, blogs, RSS feeds, and other types of information web-sites in which messages can be left or posted for a variety of social activities.

However, the present invention is not limited to the social networking services described and other public and private social networking services can also be used to practice the invention.

### Security and Encryption

Network devices 12, 14, 16, 20, 22, 24, 26 with wired and/or wireless interfaces of the present invention include one or more of the security and encryptions techniques discussed herein for secure communications on the communications network 18.

Application programs 58 (FIG. 2) include security and/or encryption application programs integral to and/or separate from the applications 30, 30′ Security and/or encryption programs may also exist in hardware components on the network devices (12, 14, 16, 20, 22, 24, 26) described herein and/or exist in a combination of hardware, software and/or firmware.

Wireless Encryption Protocol (WEP) (also called “Wired Equivalent Privacy) is a security protocol for WiLANs defined in the IEEE 802.11b standard. WEP is cryptographic privacy algorithm, based on the Rivest Cipher 4 (RC4) encryption engine, used to provide confidentiality for 802.11b wireless data.

RC4 is cipher designed by RSA Data Security, Inc. of Bedford, Mass., which can accept encryption keys of arbitrary length, and is essentially a pseudo random number generator with an output of the generator being XORed with a data stream to produce encrypted data.

One problem with WEP is that it is used at the two lowest layers of the OSI model, the physical layer and the data link layer, therefore, it does not offer end-to-end security. One another problem with WEP is that its encryption keys are static rather than dynamic. To update WEP encryption keys, an individual has to manually update a WEP key. WEP also typically uses 40-bit static keys for encryption and thus provides “weak encryption,” making a WEP device a target of hackers.

The IEEE 802.11 Working Group is working on a security upgrade for the 802.11 standard called “802.11i.” This supplemental draft standard is intended to improve WiLAN security. It describes the encrypted transmission of data between systems 802.11X WiLANs. It also defines new encryption key protocols including the Temporal Key Integrity Protocol (TKIP). The IEEE 802.11i draft standard, version 4, completed Jun. 6, 2003, is incorporated herein by reference.

The 802.11i is based on 802.1x port-based authentication for user and device authentication. The 802.11i standard includes two main developments: Wi-Fi Protected Access (WPA) and Robust Security Network (RSN).

WPA uses the same RC4 underlying encryption algorithm as WEP. However, WPA uses TKIP to improve security of keys used with WEP. WPA keys are derived and rotated more often than WEP keys and thus provide additional security. WPA also adds a message-integrity-check function to prevent packet forgeries.

RSN uses dynamic negotiation of authentication and selectable encryption algorithms between wireless access points and wireless devices. The authentication schemes proposed in the draft standard include Extensible Authentication Protocol (EAP). One proposed encryption algorithm is an Advanced Encryption Standard (AES) encryption algorithm.

Dynamic negotiation of authentication and encryption algorithms lets RSN evolve with the state of the art in security, adding algorithms to address new threats and continuing to provide the security necessary to protect information that WiLANs carry.

The NIST developed a new encryption standard, the Advanced Encryption Standard (AES) to keep government information secure. AES is intended to be a stronger, more efficient successor to Triple Data Encryption Standard (3DES).

DES is a popular symmetric-key encryption method developed in 1975 and standardized by ANSI in 1981 as ANSI X.3.92, the contents of which are incorporated herein by reference. As is known in the art, 3DES is the encrypt-decrypt-encrypt (EDE) mode of the DES cipher algorithm. 3DES is defined in the ANSI standard, ANSI X9.52-1998, the contents of which are incorporated herein by reference. DES modes of operation are used in conjunction with the NIST Federal Information Processing Standard (FIPS) for data encryption (FIPS 46-3, October 1999), the contents of which are incorporated herein by reference.

The NIST approved a FIPS for the AES, FIPS-197. This standard specified “Rijndael” encryption as a FIPS-approved symmetric encryption algorithm that may be used by U.S. Government organizations (and others) to protect sensitive information. The NIST FIPS-197 standard (AES FIPS PUB 197, November 2001) is incorporated herein by reference.

The NIST approved a FIPS for U.S. Federal Government requirements for information technology products for sensitive but unclassified (SBU) communications. The NIST FIPS Security Requirements for Cryptographic Modules (FIPS PUB 140-2, May 2001) is incorporated herein by reference.

RSA is a public key encryption system which can be used both for encrypting messages and making digital signatures. The letters RSA stand for the names of the inventors: Rivest, Shamir and Adleman. For more information on RSA, see U.S. Pat. No. 4,405,829, now expired, incorporated herein by reference.

“Hashing” is the transformation of a string of characters into a usually shorter fixed-length value or key that represents the original string. Hashing is used to index and retrieve items in a database because it is faster to find the item using the shorter hashed key than to find it using the original value. It is also used in many encryption algorithms.

Secure Hash Algorithm (SHA), is used for computing a secure condensed representation of a data message or a data file. When a message of any length<2⁶⁴ bits is input, the SHA-1 produces a 160-bit output called a “message digest.” The message digest can then be input to other security techniques such as encryption, a Digital Signature Algorithm (DSA) and others which generates or verifies a security mechanism for the message. SHA-512 outputs a 512-bit message digest. The Secure Hash Standard, FIPS PUB 180-1, Apr. 17, 1995, is incorporated herein by reference.

Message Digest-5 (MD-5) takes as input a message of arbitrary length and produces as output a 128-bit “message digest” of the input. The MD5 algorithm is intended for digital signature applications, where a large file must be “compressed” in a secure manner before being encrypted with a private (secret) key under a public-key cryptosystem such as RSA. The IETF RFC-1321, entitled “The MD5 Message-Digest Algorithm” is incorporated here by reference.

Providing a way to check the integrity of information transmitted over or stored in an unreliable medium such as a wireless network is a prime necessity in the world of open computing and communications. Mechanisms that provide such integrity check based on a secret key are called “message authentication codes” (MAC). Typically, message authentication codes are used between two parties that share a secret key in order to validate information transmitted between these parties.

Keyed Hashing for Message Authentication Codes (HMAC), is a mechanism for message authentication using cryptographic hash functions. HMAC is used with any iterative cryptographic hash function, e.g., MD5, SHA-1, SHA-512, etc. in combination with a secret shared key. The cryptographic strength of HMAC depends on the properties of the underlying hash function. The IETF RFC-2101, entitled “HMAC: Keyed-Hashing for Message Authentication” is incorporated here by reference.

An Electronic Code Book (ECB) is a mode of operation for a “block cipher,” with the characteristic that each possible block of plaintext has a defined corresponding cipher text value and vice versa. In other words, the same plaintext value will always result in the same cipher text value. Electronic Code Book is used when a volume of plaintext is separated into several blocks of data, each of which is then encrypted independently of other blocks. The Electronic Code Book has the ability to support a separate encryption key for each block type.

Diffie and Hellman (DH) describe several different group methods for two parties to agree upon a shared secret in such a way that the secret will be unavailable to eavesdroppers. This secret is then converted into various types of cryptographic keys. A large number of the variants of the DH method exist including ANSI X9.42. The IETF RFC-2631, entitled “Diffie-Hellman Key Agreement Method” is incorporated here by reference.

The HyperText Transport Protocol (HTTP) Secure (HTTPs), is a standard for encrypted communications on the World Wide Web. HTTPs is actually just HTTP over a Secure Sockets Layer (SSL). For more information on HTTP, see IETF RFC-2616 incorporated herein by reference.

The SSL protocol is a protocol layer which may be placed between a reliable connection-oriented network layer protocol (e.g. TCP/IP) and the application protocol layer (e.g. HTTP). SSL provides for secure communication between a source and destination by allowing mutual authentication, the use of digital signatures for integrity, and encryption for privacy.

The SSL protocol is designed to support a range of choices for specific security methods used for cryptography, message digests, and digital signatures. The security method are negotiated between the source and destination at the start of establishing a protocol session. The SSL 2.0 protocol specification, by Kipp E. B. Hickman, 1995 is incorporated herein by reference. More information on SSL is available at the domain name See “netscape.com/eng/security/SSL_2.html.”

Transport Layer Security (TLS) provides communications privacy over the Internet. The protocol allows client/server applications to communicate over a transport layer (e.g., TCP) in a way that is designed to prevent eavesdropping, tampering, or message forgery. For more information on TLS see IETF RFC-2246, incorporated herein by reference.

In one embodiment, the security functionality includes Cisco Compatible EXtensions (CCX). CCX includes security specifications for makers of 802.11xx wireless LAN chips for ensuring compliance with Cisco's proprietary wireless security LAN protocols. As is known in the art, Cisco Systems, Inc. of San Jose, Calif. is supplier of networking hardware and software, including router and security products.

However, the present invention is not limited to such security and encryption methods described herein and more, fewer and/or other types of security and encryption methods can be used to practice the invention. The security and encryption methods described herein can also be used in various combinations and/or in different layers of the protocol stack 38 with each other.

### Debt Instruments

“Debt instruments” are typically agreements where a lender (e.g., financial institution, investment group, government, etc.) agrees to loan a borrower money in exchange for set payments of principal and interest over a set period of time. A bond is a type of debt instrument.

A “bond” is a debt investment in which an investor loans money to an entity (e.g., corporate, governmental, etc.) that borrows the funds for a defined period of time at a fixed interest rate. Bonds are used by companies, municipalities, states and U.S. and foreign governments to finance a variety of projects and activities.

The indebted entity (issuer) issues a bond that states the interest rate (coupon) that will be paid and when the loaned funds (bond principal) are to be returned (maturity date). Interest on bonds is usually paid every six months (semi-annually). The main categories of bonds are corporate bonds, municipal bonds, and U.S. Treasury bonds, notes and bills. Two features of a bond—credit quality and duration—are the principal determinants of a bond's interest rate. US Treasury Bond maturities range from a 90-day Treasury bill to a 30-year government bond. Corporate and municipals are typically in the three to 10-year range.

### Equity Instruments

An “equity instrument” is a tradable asset of any kind; either cash, evidence of an ownership interest in an entity, or a contractual right to receive or deliver cash or another financial instrument. Equity instruments can be thought of as easily tradeable packages of capital, each having their own unique characteristics and structure

Equity instruments typically include papers that demonstrate an ownership interest in a business. Unlike debt instruments, equity instruments cede ownership, and some control, of a business to investors who provide private capital to a business. Stocks are one type of equity instruments.

### Sustainable Performance Instruments

The method and system described herein provide a new type of financial instruments called Sustainable Performance Instruments (SPI). SPI provide investors with returns tied to the actual performance outcomes or impacts from a sustainable program and/or project. The SPI incentivize investors with higher returns and/or borrowers with lower rates based on a scale on social and/or environmental and/or other objectives. The SPIs are a new way to fund innovative projects in public and private sectors that may not be able to find financing or funding using conventional mechanisms. Projects including environmental and/or social and/or other any other type of public and/or private based projects or other public and private policy interventions may use these instruments to raise financing. The SPI hold executors of the project and/or program accountable by directly tying financial returns to actual measurable performance benchmarks or observable impacts. The proposed SPI bring investment in social and/or environmental objectives and/or other any other type of public and/or private and/or other projects outside the domain of philanthropy and into the realm of mainstream financial investments and/or financial instruments. Proposed SPI design provides for a novel way of sharing the gains from achievement of the policy objective between the public and private sector.

A SPI can be designed in the form of a debt instrument such as bonds, etc. entitled, “Sustainable Bonds,” an equity instrument, such as cash, stocks, etc. entitled, “Sustainable Equities,” or other forms of financial instruments including convertibles.

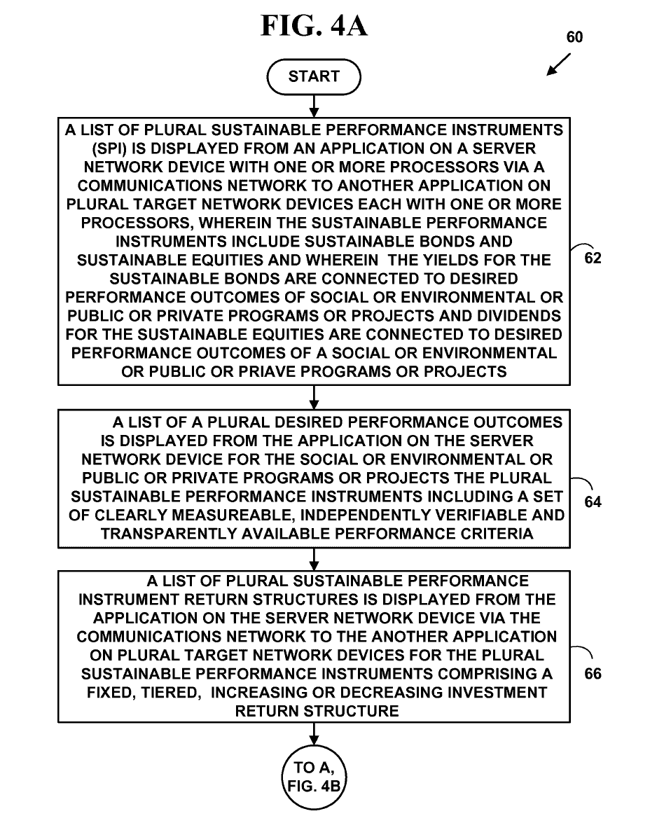

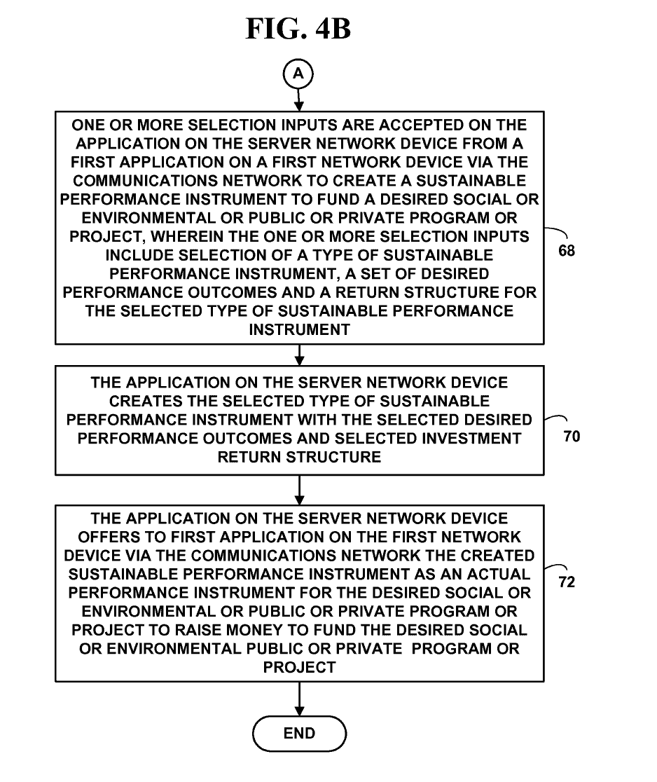

FIGS. 4A and 4B are a flow diagram illustrating a Method 60 for providing sustainable performance instruments. In FIG. 4A, at Step 62, a list of plural sustainable performance instruments (SPI) is displayed from an application on a server network device with one or more processors via a communications network to another application on plural target network devices each with one or more processors. The sustainable performance instruments include sustainable bonds, sustainable equities and other financial variants. The yields for the sustainable bonds are connected to desired performance outcomes of social or environmental or other public or private programs or other projects and dividends for the sustainable equities are connected to desired performance outcomes of a social or environmental programs or other public or private or other projects. At Step 64, a list of a plural desired performance outcomes is displayed from the application on the server network device for the social or environmental or other public or private programs or projects the plurality of sustainable performance instruments including a set of clearly measurable, independently verifiable and transparently available performance criteria. At Step 66, a list of plural sustainable performance instrument return structures is displayed from the application on the server network device via the communications network to the another application on plural target network devices for the plural sustainable performance instruments comprising a fixed, tiered, increasing or decreasing investment return structure. In FIG. 4B at Step 68, one or more selection inputs are accepted on the application on the server network device from a first application on a first network device via the communications network to create a sustainable performance instrument to fund a desired social or environmental or other public or private program or project. The one or more selection inputs include selection of a type of sustainable performance instrument, a set of desired performance outcomes and a return structure for the selected type of sustainable performance instrument. At Step 70, the application on the server network device creates the selected type of sustainable performance instrument with the selected desired performance outcomes and selected investment return structure. At Step 72, the application on the server network device offers to first application on the first network device via the communications network the created sustainable performance instrument as an actual financial instrument for the desired social or environmental program or other projects to raise money to fund the desired social or environmental or other public or private program or project.

Method 60 is illustrated with one exemplary embodiment of the invention. However, the present invention is not limited to such an exemplary embodiment and other embodiments can be used to practice the invention.

In such an exemplary embodiment, in FIG. 4A at Step 62 a list of plural sustainable performance instruments 13, 15 is displayed from an application 30′ (30 prime) on a server network device 20, 22, 24, 26 with one or more processors via a communications network 18 to another application 30 on plural target network devices 12, 14, 16 each with one or more processors (e.g., on GUI 34, etc.) The sustainable performance instruments 13, 15 include sustainable bonds 13 and sustainable equities 15 or other financial variants.

The yields for the sustainable bonds 13 are connected to desired performance outcomes of social or environmental or other public or private programs or projects and dividends for the sustainable equities 15 are connected to desired performance outcomes of a social and/or environmental and/or other public or private programs and/or projects.

The social programs and/or projects, include, but are not limited to, reductions in homelessness, recidivism, improvements in education, health & sanitation, microfinance, etc. However, the present invention is not limited to such social project and/or programs and more, fewer or other types of social projects and/or programs can be used to practice the invention.

The environmental programs and/or projects, include but are not limited to, increasing biodiversity, decreasing, water pollution, air pollution, noise pollution, developing clean and/or alternative sources of energy, etc. However, the present invention is not limited to such environmental projects and/or programs and more, fewer or other types of environmental projects and/or programs can be used to practice the invention.

The other public or private programs include public or private policy intervention with pre-determined and measurable performance criteria. The measurable performance criteria can be based on one policy goal or multiple goals. However, the present invention is not limited to public or private projects and/or programs and more, fewer or other types of projects and/or programs can be used to practice the invention.

Table 1 illustrates exemplary entities that provide the plural sustainable performance instruments 13, 15 at Step 62. However, the present invention is not limited to these entities and more, fewer or other types of entities can be used to practice the invention.

TABLE 1
The agencies involved in a typical SPI involve one or more of the
following. Alternatively, multiple functions defined below may be
performed by a single agency as well.

| | |
|---|---|
| 1. | An Administrative Agency, such as Government or Development |
| | bank, that is interested in achieving a sustainable outcome such as |
| | social, environmental or other public objective. This agency may be |
| | charged with achieving such an outcome or maybe a beneficiary of |
| | such outcomes. |
| 2. | Investor Groups, who are interested in allocating resources and |
| | capital with returns tied to clearly identifiable project outcomes. |
| 3. | Implementation Groups, charged with executing intervention |
| | programs with the goal of achieving set performance outcomes as |
| | identified in the SPI contract design. |
| 4. | A Mediator Agency that is the inter-mediator between |
| | Administrative Agency, Investor Groups, and Implementation |
| | groups. The SPI Mediator agency seeks to manage the investors' |
| | funds to maximize program outcomes as per its contract with the |
| | Administrative agency. In that role, it chooses appropriate SPI |
| | design, assigns performance criteria and returns, calls for funding |
| | from investors and chooses program interventions and |
| | Implementation groups that maximize program goals. The SPI |
| | Mediator can be a separate agency or a division within the |
| | Administrative agency. |

In one embodiment, at Step 62, the application 30 on the target network device is a smart phone or electronic table application 30. However, the present invention is not limited to such an embodiment and other types of applications can be used to practice the invention.

At Step 64, a list of a plural desired performance outcomes 17 is displayed from the application 30′ on the server network device 20, 22, 24, 26 to the another application 30 on plural target network devices 12, 14, 16 each with one or more processors (e.g., on GUI 34, etc.) for the social or environmental programs and/or other projects the plural sustainable performance instruments 13, 15 including a set of clearly measurable, independently verifiable and transparently available performance criteria. The measurable performance criteria can be based on one policy goal or multiple goals.

The social and/or environmental or other public or private projects and/or other programs have clear performance criteria defined at Step 64 that clearly measurable, independently verifiable and transparently available. The social and/or environmental or other public or private project and/or programs performance criteria also do not include any conflict of interests with the involved actors and/or entities.

The social project and/or program performance criteria, include for example, a desired percentage reduction (e.g., 5%, 10%, etc.) in homelessness and/or recidivism, a desired percentage increase in education test scores, (e.g., 10%, 15%, etc.). However, the present invention is not limited to such social projects and/or program performance criteria and more, fewer or other types of social projects and/or programs can be used to practice the invention.

The environmental project and/or program performance criteria, include for example, a desired percentage reduction (e.g., 5%, 10%, etc.) in air, water, noise pollution, a desired percentage increase clean or alternative energy, (e.g., 10%, 15%, etc.). However, the present invention is not limited to such social project and/or program performance criteria and more, fewer or other types of environmental projects and/or programs can be used to practice the invention.

At Step 66, a list of plural sustainable performance instruments return structures 19 is displayed from the application 30′ on the server network device 20, 22, 24, 26 to the another application 30 plural target network devices 12, 14, 16 each with one or more processors (e.g., on GUI 34, etc.) for the plural sustainable performance instruments comprising a fixed, tiered, increasing or decreasing return structure.

The SPI financial instrument returns are structured in a variety of ways depending on the objective of the Administrative agency. A basic motivation is to have returns tied to specific performance outcomes as defined clearly in an SPI contract with investors. In the case of a debt instrument such as a Sustainable Bond, a return may be a yield tied to the performance outcome and in case of a Sustainable Equities a dividend is tied to the achievement of a performance outcome or other yield or performance of another financial variant.

Table 2 illustrates exemplary plural sustainable performance instruments return structures 19 at Step 66. However, the present invention is not limited to these entities and more, fewer or other types of entities can be used to practice the invention.

TABLE 2

| | |
|---|---|
| a. | Fixed returns: The returns (bond yields or stock dividends) are fixed |
| | based on achievement of a pre-determined goal. Example: |
| | Improvement of school performance by 5% or more in 5 years |
| | provides returns of 2%. |
| b. | Tiered returns: The return structure are tiered (increase or decrease) |
| | based on the level of performance outcome. For example, in a tiered |
| | up scenario, improvement of school performance by 5% can return |
| | yield of 2%, and improvement of school performance by 7% can |
| | return yield of 3% and so on. |
| c. | Increasing returns: The return structure are designed in a way that |
| | based on the level of increasing performance outcomes, the return |
| | increases. |
| d. | Decreasing returns: The returns structure are designed in such a way |
| | that based on decreasing performance outcomes, the returns may |
| | decrease. This provides a tangible reward to the issuers in the form |
| | of reduced interest disbursements. |

Other variations and combinations of return structures 19 based on the Table 2 may be constructed depending on a determined objective. For example, a tiered return structure is used and allowed to increase up to a certain level of performance outcome and then a decrease return structure is used, or vice versa, etc.

The choice of the SPI return structure 19 takes into account a specific public policy objective of an SPI Administrator, risk and sustainability appetite of the investors etc. For example, designed with a public-private partnership objective, a tiered return design for SPI can have a base return and an additional return based on the achievement of the sustainable objective such that the addition is a certain share of the savings to the Administrator from the objective being reached. Many different combinations or variants for achieving the policy of the SPI exist and can be used.

Table 3 illustrates exemplary plural sustainable performance instruments return structures 19. However, the present invention is not limited to these entities and more, fewer or other types of entities can be used to practice the invention.

TABLE 3

| Sustainable Goals | SPI Instrument | Return Structures | Measurement Criteria |
|---|---|---|---|
| Social Objectives | Sustainable Bonds | Fixed | Existing performance |
| (e.g. homelessness, | | | indices |
| recidivism, education, | | | |
| health & sanitation, | | | |
| microfinance, etc,.) | | | |
| Environmental Objectives | Sustainable Equity | Increasing | Outcome Impact |
| (e.g. biodiversity, water, air, | | | Indicators |
| noise, pollution, etc.) | | | |
| Other goals | Other SPI structures | Decreasing | Custom indicators |
| | (e.g. convertibles) | | |
| Other goals | Other SPI structures | Variable | Custom indicators |
| | (e.g. convertibles) | | |

In FIG. 4B at Step 68, one or more selection inputs are accepted on the application 30′ on the server network device 20, 22, 24, 26 from a first application 30 on a first network device (e.g., 12, etc.) via the communications network 18 to create a sustainable performance instrument 13, 15 to fund a desired social or environmental or other public or private program or project. The one or more selection inputs include selection of a type of sustainable performance instrument 13, 15, a set of desired performance outcomes 17 and a return structure 19 for the selected type of sustainable performance instrument, 13, 15.

At Step 70, the application 30′ on the server network device 20, 22, 24, 26 creates the selected type of sustainable performance instrument 13, 15 with the selected desired performance outcomes 17 and selected investment return structure 19. In one embodiment, the created SPI is a financial contract. However, the present invention is not limited to these embodiments and other embodiments can be used to practice the invention.

At Step 72, the application 30′ on the server network device 20, 22, 24, 26 offers to the first application 30 on the first network device 12 via the communications network 18 the created sustainable performance instrument 13, 15 as an actual financial instrument (e.g., actual bond, stock certificate, etc.) for the desired social or environmental or other public or private program or project to raise money to fund the desired social or environment program or project. The actual financial instrument is offered and/or traded via established financial institutions, government institution, broker, trading exchanges, etc.

Method 60 is illustrated with two hypothetical examples. However, the present invention is not limited to such examples.

### HYPOTHETICAL EXAMPLE 1

Tables 4 and 5 illustrate an exemplary use of Method 60 for providing a SPI financial instrument for improving student performance in California Public Schools in a specified school district is presented here. In this example we will use a tiered system of returns based on the achievement of the performance criteria.

TABLE 4

| Purpose | To improve student performance in public | |
|---|---|---|
| | schools in District 1 in the State of California at | |
| | the end of 5 years | |
| Benchmark Measurement Criteria | Academic Performance Index for California | |
| | schools | |
| Total Funding Requested | $5,000,000 | |
| Program Start Date | January 1, 2013 | |
| Program End date | December 31, 2016 | |
| SIF Instrument | Bond | |
| Performance Criteria | The average performance in CA schools in | |
| | District 1 must increase by at least 10% after 5 | |
| | years | |
| Benchmark initial measure for specific | Assume District 1 in California has 2 schools | |
| schools | School 1: API Jan 1, 2012 is 4 | |
| | School 2: API Jan 1, 2012 is 6 | |
| | Average API for district 1 schools is 5 | |
| Minimum Investment in Sustainable Bond | $100,000 | |
| Eligible Investors | Pension Funds; philanthropic organizations; | |
| | High net worth individuals | |
| Rate of return structure | The return structure will be tiered and | |
| | increasing based on the level of performance. | |
| | Base yield: 5% irrespective of API score at end | |
| | of 5 years. | |
| | The incremental returns are tied to actual API | |
| | scores from District 1 schools based on | |
| | following tiers: | |
| | Average API | Aggregate Yield (%) |
| | Base Yield | 5% |
| | 20% from Initial | 15% |
| | reference | |
| | 40% from initial | 20% |
| | reference | |
| | 60% from initial | 25% |
| | reference | |

If API scores are between the above tiers,
returns will be adjusted on a pro rata basis

Based on Table 4, if an investor A invests $500,000 in the Sustainable Bond instrument the investor will get the following returns based on the average API scores in District 1 as is illustrated in Table 5.

TABLE 5

| | | | Return to |
|---|---|---|---|
| | API Score on | Return | Investor ($) at |
| Social Outcome | December 31, 2016 | (%) | end of Period |
| School Performance | API = 5 | 5% base | $25,000 |
| remains the same | | yield | |
| as reference level | | | |
| School Performance | API = 6 | 15% | $75,000 |
| increases 20% from | | | |
| reference level | | | |
| School performance | API = 7 | 20% | $100,000 |
| increases 40% from | | | |
| reference level | | | |

### HYPOTHETICAL EXAMPLE 2

Tables 6 and 7 illustrate an exemplary use of Method 60 for providing a SPI financial instrument for reducing violent crime in the city of Chicago. In this example, a SPI design and return structure motivated with a specific policy objective of public-private partnership is illustrated.

Consider the social problem of violent crime in the city of Chicago. According to a June 2012 report by the Center for American Progress, the total indirect and direct cost to the city from violent crime is about $5.3 billion dollars. In addition the report estimates that a 25% drop in violent crime can result in savings to the city of ˜$60 million.

Given this statistic, the City administration can consider designing a SPI with the broad objective of reducing violent crime. The instrument may be structured such that, in addition to a base rate, an increment based on actual impact achieved with regards to violent crime is also present. The proceeds for paying out the increment could come from a portion of the savings to the city from reduced crime rates. In this specific example, the city is able to make investments in a sustainable social objective by simultaneously reducing its budgetary burden and sharing the returns with the investment community.

An illustrative SPI for this objective is presented below in Tables 6 and 7.

TABLE 6

| | |
|---|---|
| Sustainable Objective | Reduction of Violent crime in Chicago |
| Measurement Criteria | City of Chicago Police Records on violent |
| | crime |
| Type of Sustainable | Sustainable Bond |
| Financing Instrument | |
| Total Issuance | $100,000,000 |
| Time period | 1 calendar year |
| Return Structure | Tiered Return with a guaranteed minimum |
| | base return and an additional return based on |
| | level of violent crime reduction achieved at the |
| | end of 1 years as follows: |
| | Base return = 2% |
| | Additional return: 25% of the accrued savings |
| | to the City from violent crime reduction. |

The actual note to the individual investor is issued in any multiple of the total issuance. Based on the above structure, the rate of return at the end of 1 year based on the reduction in violent crime can be computed as is illustrated in Table 7.

TABLE 7

| Violent Crime | | Base return | | Additional | Total Return to |
|---|---|---|---|---|---|
| Reduction | Total Issuance | (2%) | Savings to City | return | Investor |
| 0% | $100,000,000 | $2,000,000 | $0 | $0 | 2% |
| 10% | $100,000,000 | $2,000,000 | $24,000,000 | $6,000,000 | 8.00% |
| 25% | $100,000,000 | $2,000,000 | $60,000,000 | $15,000,000 | 17.00% |
| 50% | $100,000,000 | $2,000,000 | $120,000,000 | $30,000,000 | 32.00% |

As is illustrated in Table 6 and 7 both the City as well as the investor could reap significant additional returns based on the above SPI structure. There is substantial savings to the City, and hence the taxpayer, through this public-private partnership and significant returns, potentially above market rate, to the investor. This illustrates that with the right design structure SPI's can be an attractive alternative for the mainstream investment community.

Method 60 is illustrated is as an automated process that is used with server 20, 22, 24, 26 and target network devices 12, 14, 16 via a communications network 18. However, the present invention is not limited to such an automated process and the SPI's can also be practiced with various manual processes (e.g., pencil and paper, spreadsheets, etc.).

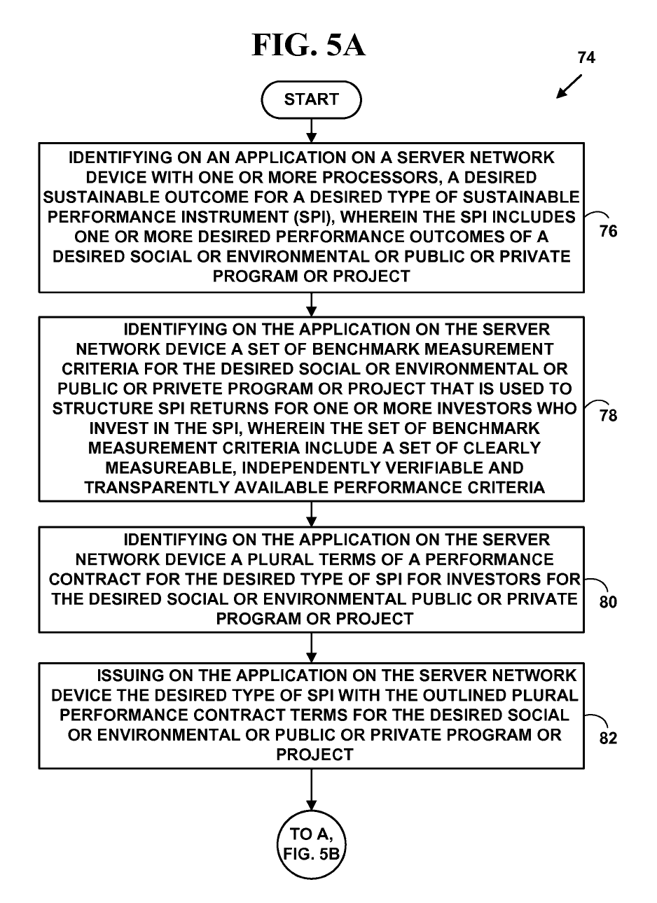

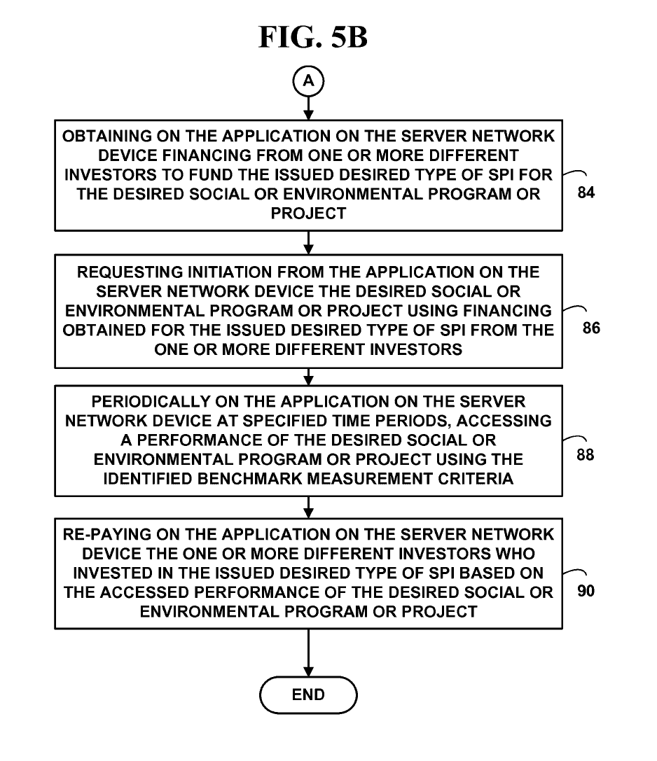

FIGS. 5A and 5B are a flow diagram illustrating a Method 74 for providing sustainable performance instruments. In FIG. 5A at Step 76, an application on a server network device with one or more processors identifies a desired sustainable outcome for a desired type of sustainable performance instrument (SPI). The SPI includes one or more desired performance outcomes of a desired social or environmental or other public or private program or project. At Step 78, the application on the server network device identifies a set of benchmark measurement criteria for the desired social or environmental or other public or private program or project that is used to structure SPI returns for one or more investors who invest in the SPI. The set of benchmark measurement criteria include a set of clearly measurable, independently verifiable and transparently available performance criteria. At Step 80, the application on the server network device identifies plural terms of a financial contract for the desired type of SPI for investors for the desired social or environmental or other public or private program or project. At Step 82, the application on the server network device issues the desired type of SPI with the outlined plural financial contract terms for the desired social or environmental or other public or private program or project. In FIG. 5B at Step 84, the application on the server network device obtains financing from one or more different investors to fund the issued desired type of SPI for the desired social or environmental or other public or private program or project. At Step 86, the application on the server network device requests initiation of the desired social or environmental or other public or private program or project using financing obtained for the issued desired type of SPI from the one or more different investors. At Step 88, the application on the server network device periodically at specified time periods, accesses a performance of the desired social or environmental or other public or private program or project using the identified benchmark measurement criteria. At Step 90, the application on the server network device re-pays the one or more different investors who invested in the issued desired type of SPI based on the accessed performance of the desired social or environmental or other public or private program or project.

Method 74 is illustrated with one exemplary embodiment of the invention. However, the present invention is not limited to such an exemplary embodiment and other embodiments can be used to practice the invention.

In such an exemplary embodiment, in FIG. 5A at Step 76, an application 30′ on a server network device 20, 22, 24, 26 with one or more processors identifies a desired sustainable outcome for a desired type of sustainable performance instrument (SPI) 13, 15 (e.g., Sustainable Bond 13 or Equity 15, etc.) The SPI 13, 15 includes one or more desired performance outcomes of a desired social or environmental or other public or private program or project.

At Step 78, the application 30′ on the server network device 20, 22, 24, 26 identifies a set of benchmark measurement criteria 17 for the desired social or environmental or other public or private program or project that is used to structure SPI 13, 15 returns for one or more investors who invest in the SPI 13, 15. The set of benchmark measurement criteria 17 include a set of clearly measurable, independently verifiable and transparently available performance criteria.

At Step 80, the application 30′ on the server network device 20, 22, 24, 26 identifies plural terms 19 of a financial contract for the desired type of SPI 13, 15 for investors for the desired social or environmental or other public or private program or project.

At Step 82, the application 30′ on the server network device 20, 22, 24, 26 issues the desired type of SPI 13, 15 with the outlined plural financial contract terms 19 for the desired social or environmental or other public or private program or project. In one embodiment, the SPI 13, 15 is issued directly and/or through a financial institution, government institution, broker, trading exchange, etc. However, the present invention is not limited to such an embodiment and other embodiments can be used to practice the invention.

In one specific embodiment, Step 82 further includes issuing from the application 30′ on the server network device 20, 22, 24, 26 the desired type of SPI 13, 15 with the outlined plural financial contract terms 19 for the desired social or environmental or other public or private program or project to a plural target network devices 12, 14, 15, each with one or more processors via the communications network 18. The SPI is displayed on plural another applications 30 on a plural graphical user interfaces 34 on the plural target network devices 12, 14, 16. However, the present invention is not limited to such an embodiment and the invention can be practiced with or without the additional steps for Step 82.

In FIG. 5B at Step 84, the application 30′ on the server network device 20, 22, 24, 26 obtains financing from one or more different investors to fund the issued desired type of SPI 13, 15 for the desired social or environmental or other public or private program or project.

At Step 86, the application 30′ on the server network device 20, 22, 24, 26 requests initiation of the desired social or environmental or other public or private program or project using financing obtained for the issued desired type of SPI 13, 15 from the one or more different investors.

At Step 88, the application 30′ on the server network device 20, 22, 24, 26 periodically at specified time periods, accesses a performance of the desired social or environmental or other public or private program or project using the identified benchmark measurement criteria 17.

At Step 90, the application 30′ on the server network device 20, 22, 24, 26 re-pays the one or more different investors who invested in the issued desired type of SPI 13, 15 based on the accessed performance 17 of the desired social or environmental or other public or private program or project.

Table 8 illustrates an example of the use of Method 74. However, the present invention is not limited to the example and details illustrated in Table and more, fewer and other details can be used to practice the invention.

TABLE 8

| | Methodology Steps | | Application Example |
|---|---|---|---|
| Step 76 | Identify the desired sustainable outcome that is | | Here a social outcome may be chosen |
| | amenable to a SPI 13, 15 product. | | such as: Improving student performance |
| | | | in California Public schools in a |
| | | | specified school district |
| Step 78 | Identify clearly the measurement criteria 17 that | | One measurement criteria could be a |
| | qualifies as the reference to design the SPI 13, 15 | | school performance index. For example |
| | returns to the investors. | | the Academic Performance Index used |
| | | | by California Schools |
| Step 80 | Identify the SPI 13, 15 contract terms, including: | | Purpose of Financing: Improve School |
| | 1. | What is purpose of the financing? | performance in a specific school district |
| | 2. | What are the total funds required? | in California |
| | 3. | What are the performance criteria and | |
| | | benchmarks? | |
| | 4. | Is there a minimum investment allowed? | |
| | 5. | Are the instruments transferable? | |
| | 6. | What is the kind of return structure? Is it | |
| | | fixed or tiered? | |
| | 7. | What is pay-off time horizon? | |
| | 8. | What are additional increments to the | |
| | | base return? | |
| | 9. | What triggers payment of the additional | |
| | | increments? | |

| | | |
|---|---|---|
| Steps | Issue SPI 13, 15 Financing instruments and raise | Use the SPI 13, 15 to fund attempted |
| 84, 86 | capital from one or more investors, | improvements in school performance. |
| Step 88 | Proceeds from the SPI 13, 15 financing are used | Introduce appropriate program |
| | to initiate planned project activity. This involves | interventions including enhancement |
| | designing the optimal program interventions to | of school infrastructure, new tutoring |
| | achieve the State's social or environmental goals | programs, afterschool activities, etc. |
| | and selection of implementation agencies to | |
| | execute the program activity. | |
| Step 90 | Periodically at specified intervals, the project | Make sure SPI 13, 15 benchmarks 17 |
| | performance is assessed against the benchmark | are actually met. |
| | performance criteria 17 for the SPI 13, 15. | |
| Step 92 | Re-payment to the investors is made accordingly | Repay investors investing in the SPI 13, |
| | to the agreed SPI 13, 15 instrument contract | 15 using the measurable SPI |
| | | benchmarks. |

Method 74 is illustrated is as an automated process that is used with server and target network devices via a communications network. However, the present invention is not limited to such an automated process and the SPI can be created with various manual processes (e.g., pencil and paper, spreadsheets, etc.).

The methods and system describe herein provide a new type of financial instruments called Sustainable performance instruments (SPI) that provides investors with returns tied to the actual performance outcomes or impacts from a sustainable social or environmental or other public or private program or project. The SPI incentivize investors with higher returns and/or borrowers with lower rates based on a scale on social and/or environmental and/or other objectives. The SPI are a new way to fund innovative projects in public and private sectors that may not be able to find financing or funding using conventional mechanisms. The SPI hold executors of the project or program accountable by directly tying financial returns to actual measurable performance benchmarks or observable impacts.

It should be understood that the architecture, programs, processes, methods and It should be understood that the architecture, programs, processes, methods and systems described herein are not related or limited to any particular type of computer or network system (hardware or software), unless indicated otherwise. Various types of general purpose or specialized computer systems may be used with or perform operations in accordance with the teachings described herein.

In view of the wide variety of embodiments to which the principles of the present invention can be applied, it should be understood that the illustrated embodiments are exemplary only, and should not be taken as limiting the scope of the present invention. For example, the steps of the flow diagrams may be taken in sequences other than those described, and more or fewer elements may be used in the block diagrams.

While various elements of the preferred embodiments have been described as being implemented in software, in other embodiments hardware or firmware implementations may alternatively be used, and vice-versa.

The claims should not be read as limited to the described order or elements unless stated to that effect. In addition, use of the term “means” in any claim is intended to invoke 35 U.S.C. §112, paragraph 6, and any claim without the word “means” is not so intended.

Therefore, all embodiments that come within the scope and spirit of the following claims and equivalents thereto are claimed as the invention.

What is claimed is:

1. A method for providing sustainable performance instruments, comprising:
providing a list of a plurality of different type of available sustainable performance instruments which are collected electronically from an application on a server network device with one or more processors via a communications network to a plurality of target applications on a plurality of target network devices each with one or more processors, the sustainable performance instruments including sustainable bonds, sustainable equities or other financial variants, wherein yields for the sustainable bonds are connected to desired performance outcomes of social or environmental or other public or private programs or other projects dividends for the sustainable equities are connected to desired and pre-determined performance outcomes of a social or environmental or other public or private programs or projects, wherein private investments and cost savings payments from an operating budget from a public or government funding source for an entity participating in the desired social or environmental program or other public or private program or project are accepted for the plurality of different types of available sustainable performance instruments for the public social or environmental projects or other public policy project, and providing the list to private investors for public-private cooperation to fund the public social or environmental projects or other public policy programs or projects that would otherwise not receive funding from investors;
providing a list of a plurality of desired performance outcomes which are determined electronically from the application on the server network device via the communications network to the plurality of target applications on the plurality of target network devices for the social or environmental or other public or private programs or projects for the plurality of different types of available sustainable performance instruments including a set of measurable, independently verifiable and transparently available performance criteria;
creating a list of a plurality of investment return structures including a base return for payments of yields or dividends paid directly from funds received from private investors and list of potential cost savings payments to be received from the operating budget of the entity participating in the desired social or environmental program or other public or private program or project used for payment of additional yields or dividends for the sustainable performance instruments, wherein the list of potential cost savings payments are connected to the desired and the pre-determined performance outcomes which are determined electronically of the social or environmental or other public or private program or project and are provided to the private investors to show a result of achieving a desired level in a final performance outcome of the desired social or environmental or other public or private program or project:
providing the list of investment return structures to the private investors from the application on the server network device via the communications network to the plurality of target applications on the plurality of target network devices for the plurality of different types of available sustainable performance instruments comprising a fixed, tiered, increasing or decreasing investment return structure;
accepting one or more selection inputs on the application on the server network device from a first target application on a first network device via the communications network to create a selected type of sustainable performance instrument to fund a desired social or environmental or other public or private program or project, the one or more selection inputs including selection of a displayed type of sustainable performance instrument, a set of desired performance outcomes and a return structure for the selected type of sustainable performance instrument;
connecting on the application on the server network device for the created type of sustainable performance instrument, yields for sustainable bonds or connecting dividends for sustainable equities to a desired and pre-determined performance outcome of the social or environmental or other public or private program or project;
creating on the application on the server network device the selected type of sustainable performance instrument with the selected desired performance outcomes and selected investment return structure as an actual financial instrument by conversion of data from the collected lists; and
offering from the application on the server network device to the first application on the first network device via the communications network the actual financial instrument for the created sustainable performance instrument for the desired social or environmental or other public or private program or project to the private investors to raise money to fund to established financial institutions, government institutions, trading exchanges or brokers;
receiving on the application on the server network device via the communications network verification of one or more investments from one or more different private investors for the actual financial instrument for the created sustainable performance instrument to provide private investments in the public social or environmental projects or public policy projects and to provide the public-private cooperation to fund the public social or environmental projects or other public policy programs or projects that would otherwise not receive funding from investors;
accessing on the application on the server network device at an end of a specified time period, a final performance outcome of the desired social or environmental or other public or private program or project determined from the desired and pre-determined performance outcome for the created sustainable performance instrument;
accepting on the application on the server network device an additional cost savings payment for the private investors for the actual financial instrument for the created sustainable performance instrument from the operating budget for the entity participating in the desired social or environmental program or other public or private program or project whenever the desired social or environmental program or other public or private program achieves a cost savings as a result of achieving a desired level in the final performance outcome of the desired social or environmental or other public or private program or project; and
initiating from the application on the server network device payment of yields or dividends to the one or more different investors who have invested in the actual financial instrument for the created sustainable performance instrument based on the accessed final performance outcome of associated desired social or environmental or other public or private program or project and the selected investment return structure for the created sustainable performance instrument including any accepted additional cost saving payment.

2. A non-transitory computer readable medium having stored therein a plurality of instructions for causing one or processors on one or more networks devices to execute the steps of:
providing a list of a plurality of different type of available sustainable performance instruments which are collected electronically from an application on a server network device with one or more processors via a communications network to a plurality of target applications on a plurality of target network devices each with one or more processors, the sustainable performance instruments including sustainable bonds, sustainable equities or other financial variants, wherein yields for the sustainable bonds are connected to desired performance outcomes of social or environmental or other public or private programs or other projects dividends for the sustainable equities are connected to desired and predetermined performance outcomes of a social or environmental or other public or private programs or projects, wherein private investments and cost savings payments from an operating budget from a public or government funding source for an entity participating in the desired social or environmental program or other public or private program or project are accepted for the plurality of different types of available sustainable performance instruments for the public social or environmental projects or other public policy project, and providing the list to private investors for public-private cooperation to fund the public social or environmental projects or other public policy programs or projects that would otherwise not receive funding from investors;
providing a list of a plurality of desired performance outcomes from the application on the server network device via the communications network to the plurality of target applications on the plurality of target network devices for the social or environmental or other public or private programs or projects for the plurality of different types of available sustainable performance instruments including a set of measurable, independently verifiable and transparently available performance criteria;
creating a list of a plurality of investment return structures including a base return for payments of yields or dividends paid directly from funds received from private investors and list of potential cost savings payments to be received from the operating budget of the entity participating in the desired social or environmental program or other public or private program or project used for payment of additional yields or dividends for the sustainable performance instruments, wherein the list of potential cost savings payments are connected to the desired and the pre-determined performance outcomes which are determined electronically of the social or environmental or other public or private program or project and are provided to the private investors to show a result of achieving a desired level in a final performance outcome of the desired social or environmental or other public or private program or project:
providing the list of investment return structures to the private investors from the application on the server network device via the communications network to the plurality of target applications on the plurality of target network devices for the plurality of different types of available sustainable performance instruments comprising a fixed, tiered, increasing or decreasing investment return structure;
accepting one or more selection inputs on the application on the server network device from a first target application on a first network device via the communications network to create a selected type of sustainable performance instrument to fund a desired social or environmental or other public or private program or project, the one or more selection inputs including selection of a displayed type of sustainable performance instrument, a set of desired performance outcomes and a return structure for the selected type of sustainable performance instrument;
connecting on the application on the server network device for the created type of sustainable performance instrument, yields for sustainable bonds or connecting dividends for sustainable equities to a desired and pre-determined performance outcome of the social or environmental or other public or private program or project;
creating on the application on the server network device the selected type of sustainable performance instrument with the selected desired performance outcomes and selected investment return structure as an actual financial instrument by conversion of data from the collected lists; and
offering from the application on the server network device to the first application on the first network device via the communications network the actual financial instrument for the created sustainable performance instrument for the desired social or environmental or other public or private program or project to the private investors to raise money to fund to established financial institutions, government institutions, trading exchanges or brokers;
receiving on the application on the server network device via the communications network verification of one or more investments from one or more different private investors for the actual financial instrument for the created sustainable performance instrument to provide private investments in the public social or environmental projects or public policy projects and to provide the public-private cooperation to fund the public social or environmental projects or other public policy programs or projects that would otherwise not receive funding from investors;
accessing on the application on the server network device at an end of a specified time period, a final performance outcome of the desired social or environmental or other public or private program or project determined from the desired and pre-determined performance outcome for the created sustainable performance instrument;
accepting on the application on the server network device an additional cost savings payment for the actual financial instrument for the created sustainable performance instrument from the operating budget for the entity participating in the desired social or environmental program or other public or private program or project whenever the desired social or environmental program or other public or private program achieves a cost savings as a result of achieving a desired level in the final performance outcome of the desired social or environmental or other public or private program or project; and
initiating from the application on the server network device payment of yields or dividends to the one or more different investors who invested in the actual financial instrument for the created sustainable performance instrument based on the accessed final performance outcome of associated desired social or environmental or other public or private program or project, and the selected investment return structure for the created sustainable performance instrument including any accepted additional cost saving payment.

3. The method of claim 1 wherein, the type of sustainable performance instrument includes a Sustainable Bond or Sustainable Equity financial instrument or other financial variants.

4. The method of claim 1 wherein the fixed sustainable investment return structure includes a fixed return based on achievement of one or more predetermined social or environmental or other public or private program or project goals.

5. The method of claim 1 wherein the tiered sustainable investment return structure includes a tiered increasing or decreasing return based on a level of performance outcome for a social or environmental or other public or private program or project.

6. The method of claim 1 wherein the increasing sustainable investment return structure includes an increasing return based on an increasing level of performance outcomes for a social or environmental or other public or private program or project.

7. The method of claim 1 wherein the decreasing sustainable investment return structure includes a decreasing return based on a decreasing level of performance outcomes for a social or environmental or other public or private program or project.

8. The method of claim 1 wherein step of offering securely includes offering securely using a Wireless Encryption Protocol (WEP), Wireless-Wi-Fi Protected Access (WPA), Robust Security Network (RSN), Advanced Encryption Standard (AES), Data Encryption Standard (DES), Triple Data Encryption Standard (3DES), Secure Hash Algorithm (SHA), Message Digest-5 (MD-5), Electronic Code Book (ECB), Diffie and Hellman (DH), HyperText Transport Protocol Secure, (HTTPs), Secure Sockets Layer (SSL), Transport Layer Security (TLS) security method.

9. The method of claim 1 wherein the communications network is a wireless communications network.

10. The method of claim 9 wherein the server network device and the plurality of target network devices include a wireless networking interface comprising a Worldwide Interoperability for Microwave Access (WiMax) wireless networking interface with 4^{th} generation (4G) wireless speeds for communicating with the communications network.

11. The method of claim 1 wherein the plurality of target network devices include a smart phone or a tablet computer.

12. The method of claim 1 wherein the other application is an application for a smart phone or a tablet computer.

13. The method of claim 1 wherein the actual financial instrument is a stock or a bond offered by a financial institution, government institution, broker, or a trading exchange.

14. The method of claim 1 further comprising:
identifying on the application on the server network device with one or more processors, a desired sustainable outcome for a desired type of sustainable performance instrument (SPI), wherein the SPI includes one or more desired performance outcomes of a desired social or environmental or other public or private program or project;
identifying on the application on the server network device a set of benchmark measurement criteria for the desired social or environmental or other public or private program or project that is used to structure SPI returns for one or more investors who invest in the SPI, wherein the set of benchmark measurement criteria include a set of measurable, independently verifiable and transparently available performance criteria;
identifying on the application on the server network device a plurality of terms of a financial contract for the desired type of SPI for investors for the desired social or environmental or other public or private program or project;
issuing on the application on the server network device the desired type of SPI with the outlined plurality of financial contract terms for the desired social or environmental or other public or private program or project;
obtaining on the application on the server network device financing from one or more different investors to fund the issued desired type of SPI for the desired social or environmental or other public or private program or project;
requesting initiation from the application on the server network device the desired social or environmental or other public or private program or project using financing obtained for the issued desired type of SPI from the one or more different investors;
periodically on the application on the server network device at specified time periods, accessing a performance of the desired social or environmental or other public or private program or project using the identified benchmark measurement criteria; and
re-paying on the application on the server network device the one or more different investors who invested in the issued desired type of SPI based on the accessed performance of the desired social or environmental or other public or private program or project.

15. The method of claim 14 wherein the desired type of SPI includes a Sustainable Bond or a Sustainable Equity financial instrument.

16. The method of claim 14 wherein the desired type of SPI includes a fixed, tiered, increasing or decreasing SPI return structure.

17. The method of claim 16 wherein the fixed SPI return structure includes a fixed return based on achievement of one or more pre-determined social or environmental or other public or private program or project goals, a tiered increasing or decreasing return based on a level of performance outcome for the social or environmental or other public or private program or project, an increasing return based on an increasing level of performance outcomes for the social or environmental or other public or private program or project or includes an decreasing return based on an decreasing level of performance outcomes for the social or environmental or other public or private program or project.

18. The method of claim 14 wherein the issuing step includes:
issuing from the application on the server network device the desired type of SPI with the outlined plurality of financial contract terms for the desired social or environmental or other public or private program or project to a plurality of target network devices, each with one or more processors via the communications network; and
displaying the SPI on a plurality of another applications on a plurality of graphical user interfaces on the plurality of target network devices.

19. A system for providing sustainable performance instruments comprising in combination:
one or more network devices each with one or more processors connected to a communications network, the one or more network devices executing a plurality of instructions in one or more non-transitory computer readable mediums and configured for:
for providing a list of a plurality of different type of available sustainable performance instruments which are collected electronically from an application on a server network device with one or more processors via a communications network to a plurality of target applications on a plurality of target network devices each with one or more processors, the sustainable performance instruments including sustainable bonds, sustainable equities or other financial variants, wherein yields for the sustainable bonds are connected to desired performance outcomes of social or environmental or other public or private programs or other projects dividends for the sustainable equities are connected to desired and pre-determined performance outcomes of a social or environmental or other public or private programs or projects, wherein private investments and cost savings payments from an operating budget from a public or government funding source for an entity participating in the desired social or environmental program or other public or private program or project are accepted for the plurality of different types of available sustainable performance instruments for the public social or environmental projects or other public policy project, and providing the list to private investors for public-private cooperation to fund the public social or environmental projects or other public policy programs or projects that would otherwise not receive funding from investors;
for providing a list of investment return structures to the private investors from the application on the server network device via the communications network to the plurality of target applications on the plurality of target network devices for the social or environmental or other public or private programs or projects for the plurality of different types of available sustainable performance instruments including a set of measurable, independently verifiable and transparently available performance criteria;
for creating a list of a plurality of investment return structures including a base return for payments of yields or dividends paid directly from funds received from private investors and list of potential cost savings payments to be received from the operating budget of the entity participating in the desired social or environmental program or other public or private program or project used for payment of additional yields or dividends for the sustainable performance instruments, wherein the list of potential cost savings payments are connected to the desired and the pre-determined performance outcomes which are determined electronically of the social or environmental or other public or private program or project and are provided to the private investors to show a result of achieving a desired level in a final performance outcome of the desired social or environmental or other public or private program or project;
for providing the list of investment return structures to the private investors from the application on the server network device via the communications network to the plurality of target applications on the plurality of target network devices for the plurality of different types of available sustainable performance instruments comprising a fixed, tiered, increasing or decreasing investment return structure;
for accepting one or more selection inputs on the application on the server network device from a first target application on a first network device via the communications network to create a selected type of sustainable performance instrument to fund a desired social or environmental or other public or private program or project, the one or more selection inputs including selection of a displayed type of sustainable performance instrument, a set of desired performance outcomes and a return structure for the selected type of sustainable performance instrument;
for connecting on the application on the server network device for the created type of sustainable performance instrument, yields for sustainable bonds or connecting dividends for sustainable equities to a desired and pre-determined performance outcome of the social or environmental or other public or private program or project;
for creating on the application on the server network device the selected type of sustainable performance instrument with the selected desired performance outcomes and selected investment return structure as an actual financial instrument by conversion of data from the collected lists;
for offering from the application on the server network device to the first application on the first network device via the communications network the actual financial instrument for the created sustainable performance instrument for the desired social or environmental or other public or private program or project to the private investors to raise money to fund to established financial institutions, government institutions, trading exchanges or brokers;
for receiving on the application on the server network device via the communications network verification of one or more investments from one or more different private investors for the actual financial instrument for the created sustainable performance instrument to provide private investments in the public social or environmental projects or public policy projects and to provide the public-private cooperation to fund the public social or environmental projects or other public policy programs or projects that would otherwise not receive funding from investors;
for accessing on the application on the server network device at an end of a specified time period, a final performance outcome of the desired social or environmental or other public or private program or project determined from the desired and pre-determined performance outcome for the created sustainable performance instrument;
for accepting on the application on the server network device an additional cost savings payment for the actual financial instrument for the created sustainable performance instrument from the operating budget for the entity participating in the desired social or environmental program or other public or private program or project whenever the desired social or environmental program or other public or private program achieves a cost savings as a result of achieving a desired level in the final performance outcome of the desired social or environmental or other public or private program or project; and
for initiating from the application on the server network device payment of yields or dividends to the one or more different investors who invested in the actual financial instrument for the created sustainable performance instrument based on the accessed final performance outcome of associated desired social or environmental or other public or private program or project and the selected investment return structure for the created sustainable performance instrument including any accepted additional cost saving payment.

20. The system of claim 19 further comprising:
for identifying on the application on the server network device with one or more processors, a desired sustainable outcome for a desired type of sustainable performance instrument (SPI), wherein the SPI includes one or more desired performance outcomes of a desired social or environmental or other public or private program or project
for identifying on the application on the server network device a set of benchmark measurement criteria for the desired social or environmental or other public or private program or project that is used to structure SPI returns for one or more investors who invest in the SPI, wherein the set of benchmark measurement criteria include a set of measurable, independently verifiable and transparently available performance criteria;
for identifying on the application on the server network device a plurality of terms of a financial contract for the desired type of SPI for investors for the desired social or environmental or other public or private program or project;
for issuing on the application on the server network device the desired type of SPI with the outlined plurality of financial contract terms for the desired social or environmental or other public or private program or project;
for obtaining on the application on the server network device financing from one or more different investors to fund the issued desired type of SPI for the desired social or environmental or other public or private program or project;
for requesting initiation from the application on the server network device the desired social or environmental or other public or private program or project using financing obtained for the issued desired type of SPI from the one or more different investors;
for periodically on the application on the server network device at specified time periods, accessing a performance of the desired social or environmental or other public or private program or project using the identified benchmark measurement criteria; and
for re-paying on the application on the server network device the one or more different investors who invested in the issued desired type of SPI based on the accessed performance of the desired social or environmental or other public or private program or project.
